(19) United States
(12) Patent Application Publication
(10) Pub. No.: US 2025/0391922 A1
(43) Pub. Date: Dec. 25, 2025

(54) ELECTRODE ASSEMBLY AND ELECTROCHEMICAL DEVICE INCLUDING THE SAME

(71) Applicant: LG ENERGY SOLUTION, LTD., Seoul (KR)

(72) Inventors: Junghoon LEE, Daejeon (KR); Soon Kwan KWON, Daejeon (KR)

(21) Appl. No.: 18/881,245

(22) PCT Filed: Oct. 20, 2023
(86) PCT No.: PCT/KR2023/016371

§ 371 Date: Jan. 3, 2025

(30) Foreign Application Priority Data
Oct. 21, 2022 (KR) 10-2022-0136198
May 31, 2023 (KR) 10-2023-0070472
Oct. 18, 2023 (KR) 10-2023-0139636

(51) Int. Cl. H01M 10/0583; H01M 4/02; H01M 4/134; H01M 4/38; H01M 10/052; H01M 50/466; H01M 50/586; H01M 50/595

(52) U.S. Cl. CPC H01M 10/0583; H01M 4/134; H01M 4/382; H01M 10/052; H01M 50/466; H01M 50/586; H01M 50/595; H01M 2004/021; H01M 2004/027

(57) ABSTRACT

An electrode assembly including a negative electrode structure and a plurality of positive electrodes is provided. The negative electrode structure includes first and second separating films, and a negative electrode including a lithium metal layer interposed between the first and second separating films. The negative electrode structure is divided into a plurality of stack portions, a plurality of folding portions, and first and second wrapping portions according to their positions in the electrode assembly. In the negative electrode structure, the plurality of stack portions and the plurality of folding portions are positioned in an alternating manner between the first and second wrapping portions. The electrode assembly has a configuration wherein the exterior in the thickness direction and the longitudinal direction is defined by the first and second wrapping portions, or is defined by the first and second wrapping portions and at least one outermost stack portion.

### CROSS-REFERENCE TO RELATED APPLICATIONS

The present application is a National Phase entry pursuant to 35 U.S.C. § 371 of International Application No. PCT/KR2023/016371, filed on Oct. 20, 2023, and claims priority to and the benefit of Korean Patent Application No. 10-2022-0136198 filed on Oct. 21, 2022, Korean Patent Application No. 10-2023-0070472 filed on May 31, 2023, and Korean Patent Application No. 10-2023-0139636, filed on Oct. 18, 2023, the entire contents of each of which are incorporated herein by reference for all purposes as if fully set forth herein.

### TECHNICAL FIELD

Aspects of the present disclosurerelate to an electrode assembly and an electrochemical device including the same. More particularly, aspects of the present disclosure relate to an electrode assembly including lithium metal in a negative electrode and an electrochemical device including the same.

### BACKGROUND

In recent years, there has been a growing interest in energy storage technology. As utilization expands from mobile phones, camcorders and laptop PCs to energy for electric vehicles, research and development efforts have been increasing. In this regard, research and development into electrochemical devices has been one of the most promising areas, and especially, the development of secondary batteries has been drawing attention with respect to batteries that are relatively small and light weight, and that are capable of charging and discharging with high capacity, in light of the recent trend toward miniaturization and light weight of electronic devices.

Secondary batteries can be categorized by an electrode assembly generally including the structure: positive electrode/separating film/negative electrode. For example, electrode assemblies are categorized into jelly-roll (wound) electrode assemblies, which are a wound long sheet of positive electrodes and negative electrodes with separating films, and stacked electrode assemblies, wherein multiple positive electrodes and negative electrodes cut into predetermined sized units with separating films are stacked sequentially.

However, these conventional electrode assemblies can suffer from several problems.

First, the jelly-roll electrode assembly is typically made by winding the long sheet of positive electrodes and negative electrodes in a tight state, to thereby create a cylindrical or elliptical cross-section. In such a structure, stresses caused by the expansion and contraction of the electrodes during charge and discharge can accumulate in the electrode assembly, and when such stress accumulation exceeds a certain limit, deformation of the electrode can assembly occur. Furthermore, the deformation of the electrode assembly may cause uneven spacing between the electrodes, resulting in a sharp decrease in the performance of the battery, and an internal short circuit may occur, threatening the safety of the battery. Furthermore, since the jelly-roll electrode assembly requires winding a long sheet of the positive electrodes and negative electrodes, it is difficult to wind the positive electrodes and negative electrodes quickly while maintaining a constant spacing between the positive electrodes and negative electrodes, resulting in a decrease in productivity.

Second, the stackable electrode assembly typically requires sequential stacking of multiple positive electrodes and negative electrode units. In this process, since a separate pole plate transfer process is required to manufacture the unit, and the sequential stacking process requires a lot of time and effort, the stackable electrode assembly has the problem of low productivity.

To solve these problems, a stackable-foldable electrode assembly with an advanced structure that is a hybrid of the jelly-roll type and stackable type has been developed. The stackable-foldable electrode assembly has a structure in which bi-cells or full cells stacked with separating films between the positive electrodes and negative electrodes of a predetermined unit are wound using a long continuous separating film sheet (foldable separating film).

The stackable-foldable electrode assembly typically connects the electrodes of each layer by extending separating films that are easier to fold, rather than extending the electrodes. In this process, the electrodes of each layer are supplied in a cut state for formation of the electrode assembly, as in the stacked electrode assembly. In the relevant art, if the secondary battery is composed of materials that are not easily cut or folded among a variety of conventional electrode materials for secondary batteries in the art, the general stackable-foldable electrode assembly is more suitable. On the other hand, lithium metal, which is well-known as a negative electrode material for secondary batteries in the art, may not be suitable for conventional stackable-foldable electrode assemblies because it is not easy to be processed, for example by cutting, due to its physical properties such as high ductile and viscosity, although it is relatively easy to be folded.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

After continuous research on the structure of electrode assemblies, a structure has been designed that is suitable for electrode assemblies, and which may contain lithium metal as a negative electrode, according to aspects of the present disclosure.

Aspects of the present disclosure seek to provide an electrode assembly with a novel structure suitable for an electrode assembly containing lithium metal as a negative electrode, and an electrochemical device including the same.

According to a first aspect of the present disclosure, the present disclosure provides an electrode assembly comprising a negative electrode structure and a plurality of positive electrodes.

In one embodiment of the present disclosure, the negative electrode structure includes first and second separating films, and a negative electrode including a lithium metal layer interposed between the first and second separating films.

In one embodiment of the present disclosure, the negative electrode structure is divided into a plurality of stack portions, a plurality of folding portions, and first and second wrapping portions in accordance with their positions in the electrode assembly.

In one embodiment of the present disclosure, the plurality of stack portions and the plurality of folding portions are positioned in an alternating manner between the first and second wrapping portions that are located at respective ends of the negative electrode structure, wherein each of the first and second wrapping portions abut at least one of the plurality of stack portions.

In one embodiment of the present disclosure, the electrode assembly has a plurality of stack portions sequentially positioned side-by-side in a thickness direction and connected together by the plurality of folding portions, and each of the plurality of positive electrodes is positioned between stack portions that are adjacent to each other in the thickness direction.

In one embodiment of the present disclosure, the electrode assembly has a configuration in which an exterior in the thickness direction and a longitudinal direction is defined by first and second wrapping portions, or is defined by first and second wrapping portions and at least one outermost stack portion.

In one embodiment of the present disclosure, in the electrode assembly, the plurality of stack portions and the plurality of positive electrodes are pressed closer to each other in the thickness direction by the first and second wrapping portions.

In one embodiment of the present disclosure, the first wrapping portion and the second wrapping portion do not contact each other.

In one embodiment of the present disclosure, the first wrapping portion and the second wrapping portion have the same length as each other.

In one embodiment of the present disclosure, the first wrapping portion and the second wrapping portion are secured to different outermost stack portions.

In one embodiment of the present disclosure, in the electrode assembly, each of the plurality of positive electrodes is located between stack portions of the plurality of stack portions that are adjacent to each other in the thickness direction, and a total number of positive electrodes located between stack portions of the plurality of stack portions that are adjacent to each other is 2n (wherein n is a natural number).

In one embodiment of the present disclosure, in the electrode assembly, each of the plurality of positive electrodes includes a positive electrode active material layer, and a current collector supporting the positive electrode active material layer, and the negative electrode structure does not include a current collector supporting the lithium metal layer.

In one embodiment of the present disclosure, in the negative electrode structure, the lengths of the lithium metal layer and the first and second separating films are the same.

In one embodiment of the present disclosure, in the negative electrode structure, an end of the first wrapping portion is located on an outermost stack portion that connects to the second wrapping portion such that the first wrapping portion turns to wrap around a side adjacent to one side of the electrode assembly, and an end of the second wrapping portion is located on an outermost stack portion that connects to the first wrapping portion such that the second wrapping portion turns to wrap around a side adjacent to the other side of the adjacent electrode assembly.

In one embodiment of the present disclosure, the electrode assembly further comprises a fixing member securing the ends of each of the first and second wrapping portions to the outermost stack portion.

In one embodiment of the present disclosure, the lengths of the plurality of folding portions in the negative electrode structure are from 2 to 10 times the sum of the thicknesses of the positive electrode and the negative electrode structure.

In one embodiment of the present disclosure, the lengths of the plurality of folding portions in the negative electrode structure are from 2 to 10 times the vertical distance between the end of the positive electrode and the lateral wrapping portion surrounding it.

In one embodiment of the present disclosure, the plurality of folding portions have an asymmetrical shape with respect to a plane along the longitudinal direction.

In one embodiment of the present disclosure, the thickness of the lithium metal layer in the negative electrode structure is from 50% to 90% based on the overall thickness of the negative electrode structure.

In one embodiment of the present disclosure, the thickness of each positive electrode of the plurality of positive electrodes is greater than a thickness of the negative electrode structure.

In one embodiment of the present disclosure, the fixing member is an insulating tape.

In one embodiment of the present disclosure, a center point of the length of each of the plurality of folding portions is not aligned with a center point of the thickness of each of the plurality of positive electrodes respectively surrounded by the plurality of folding portions.

In one embodiment of the present disclosure, the first wrapping portion and the second wrapping portion, each located on the stack portion, do not overlap each other in the thickness direction.

In one embodiment of the present disclosure, the first wrapping portion and the second wrapping portion, each located on the stack portion, overlap each other in the thickness direction.

In one embodiment of the present disclosure, the end of the first wrapping portion and the end of the second wrapping portion are located on the same line in the thickness direction.

According to a second aspect of the present disclosure, the present disclosure provides an electrochemical device comprising the electrode assembly described above.

In one embodiment of the present disclosure, the electrochemical device is a lithium secondary battery.

In one embodiment of the present disclosure, the electrochemical device is a lithium-sulfur battery.

An electrode assembly according to one embodiment of the present disclosure is manufactured by utilizing one negative electrode structure in a continuous form interposed between two separating films with a negative electrode comprising lithium metal, thereby minimizing the cutting of lithium metal, and accordingly, improving process efficiency in manufacturing an electrode assembly.

Furthermore, by adjusting the methods and conditions of stacking, folding, and wrapping in accordance with the material properties of the negative electrode structure, not only can the manufactured electrode assembly have a stable structure, but also the performance of the battery can be improved.

### BRIEF DESCRIPTION OF DRAWING

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a schematic illustration of a structure of a negative electrode structure including a stack portion, a folding portion, and a wrapping portion, according to one embodiment of the present disclosure.

FIG. 2 is a schematic illustration of the structure of an electrode assembly including a negative electrode structure and a positive electrode, in accordance with one embodiment of the present disclosure.

FIG. 3 is a schematic illustration of the structure of an electrode assembly with the end of the wrapping portion fixed with a fixing member to the negative electrode structure, in accordance with one embodiment of the present disclosure.

FIG. 4 is a close-up schematic illustration of a folding portion of the electrode assembly according to one embodiment of the present disclosure.

FIG. 5 is a close-up schematic illustration of a portion of the electrode assembly in accordance with one embodiment of the present disclosure where the end of the positive electrode and the lateral wrapping portion are located.

FIGS. 6a-6d are diagrams schematically illustrating a process and state in a manufacturing process of the electrode assembly according to one embodiment of the present disclosure. Here, FIG. 6a schematically illustrates a process of folding a negative electrode structure to form an electrode laminate in which the positive electrode and the negative electrode structure are alternately stacked, and FIG. 6b schematically illustrates a process of wrapping one side of the electrode laminate with the first and second wrapping portions after the electrode laminate is formed. Furthermore, FIG. 6c schematically illustrates a state in which the electrode assembly is completed after wrapping, with the ends of the first and second wrapping portions located on the stack portion, and FIG. 6d schematically illustrates a state in which the ends of the first and second wrapping portions are fixed.

FIG. 7 is a graph depicting the results of measuring the cycle-by-cycle Coulombic efficiencies of the lithium secondary batteries including each of the electrode assemblies manufactured according to Example 1 and Comparative Example 1.

### DETAILED DESCRIPTION

Details of the embodiment of the present disclosure are provided in the following descriptions. It should be noted that in assigning reference numerals to the components in each drawing, identical components, even in different drawings, are given the same numerals as much as possible. In addition, in describing the embodiments, if a detailed description on a related known constitution or feature is deemed to interfere with an understanding of the embodiments, the detailed description is omitted.

In addition, terms such as first, second, A, B, (a), (b), and the like may be used to describe components of the embodiments. Such terms are intended only to distinguish one component from another, and the nature, sequence or order of such components is not limited by such terms. When a component is described as being “connected,” “coupled,” or “abutted” to another component, it is to be understood that the component may be directly connected or contacted to the other component, but another component may be “connected,” “coupled,” or “abutted” between these components.

Components included in one embodiment, and components having common functions, are described using the same terms in other embodiments. Unless otherwise indicated, descriptions in one embodiment may be applied to other embodiments, and specific descriptions which are redundant are omitted.

Aspects of the present disclosure relate to an electrode assembly, which improves problems that can occur when using lithium metal as a negative electrode in a conventional stackable-foldable electrode assembly structure to provide an electrode assembly with a novel structure suitable for using lithium metal as a negative electrode. By minimizing the processing of lithium metal, the electrode assembly according to aspects of the present disclosure can not only improve the processability of the assembly process, but also increase the reliability of the manufactured product. Furthermore, according to certain aspects, the electrode assembly has a configuration that can maximize the utilization of the positive electrode included in the electrode assembly, which can contribute to improving the performance of the battery.

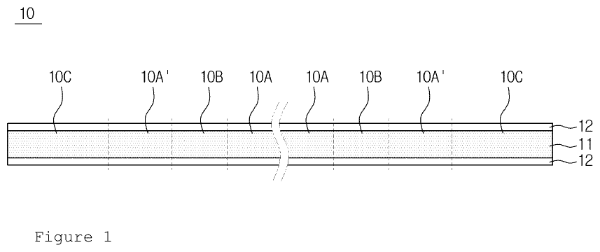

The terms “longitudinal direction,” “width direction” and “thickness direction” (or “height direction”) are used in this specification. FIGS. 1 to 6 are frontal views, and based on these frontal views, the “longitudinal direction” indicates a side-to-side (horizontal) direction, the “width direction” indicates a direction into the page, and the “thickness direction” (or “height direction”) indicates an up-and-down (vertical) direction.

As used herein, the term “adjacent” means the object that is closest to the reference object among the plurality of objects referred to thereby. An adjacent object does not necessarily have to be in contact with reference object.

An electrode assembly according to one embodiment of the present disclosure includes a positive electrode, a negative electrode and a separating film. In the electrode assembly, the positive electrode and the separating film are not particularly limited as long as they are materials commonly used in the art, but the negative electrode comprises lithium metal. As used herein, lithium metal can be broadly construed to include even a case where lithium is added with a certain component or is an alloy with a certain metal, as long as it does not significantly differ in properties from lithium metal and can be applied to conventional electrode assemblies, and which may cause the same problems as lithium metal. As used herein, the negative electrode may be referred to as a lithium metal layer in that it includes lithium metal, and the negative electrode and the separating film may be referred to as a negative electrode structure in that they are provided as a single integral structure.

According to one embodiment of the present disclosure, the negative electrode is interposed between two separating films to form a negative electrode structure. The two separating films comprising the negative electrode structure may be referred to herein as first and second separating films. The negative electrode structure has a longitudinally extending structure, and according to certain embodiments the electrode assembly includes only one negative electrode structure. According to certain embodiments, the negative electrode structure with the longitudinally elongated structure is folded to form a basic electrode assembly structure, such as fixing a positive electrode therein.

According to one embodiment of the present disclosure, the negative electrode structure includes a plurality of stack portions, a plurality of folding portions, and two wrapping portions located at different positions in the electrode assembly. In this specification, the two wrapping portions included in the negative electrode structure may be named first and second wrapping portions. To facilitate an understanding of the structure of the negative electrode structure, FIG. 1 provides an exemplary structure of a negative electrode structure including stack portions, folding portions, and wrapping portions. In the negative electrode structure (10), the stack portions (10A, 10A′), the folding portions (10B), and the wrapping portions (10C) are units having different functions according to their location along the longitudinal direction of the negative electrode structure (10). The stack portions (10A, 10A′), the folding portions (10B), and the wrapping portions (10C) are not distinguishable with respect to their materials or otherwise, other than by their relative positions.

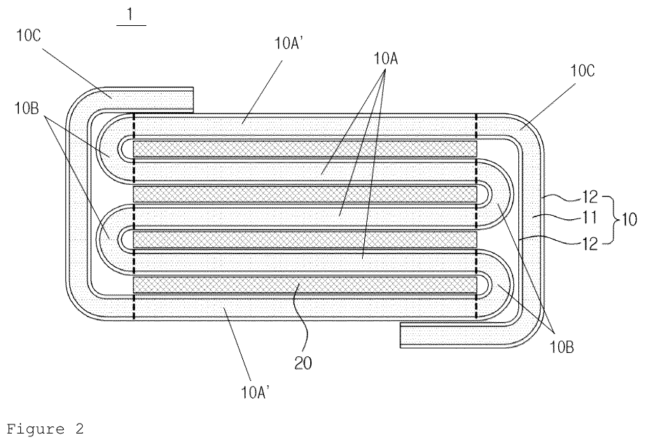

The stack portions (10A, 10A′) refer to those portions of the negative electrode structure (10) that are located at position where the positive electrodes are stacked, and primarily have a straight shape in FIG. 2. The folding portion (10B) refers to the portion of the negative electrode structure (10) that is located in a position to connect adjacent stack portions to each other, and has a predominantly curved shape in the embodiment shown in FIG. 2. The folding portion (10B) may also be named a bending portion. The wrapping portion (10C) refers to a portion of the negative electrode structure that is located in a position where it wraps the stacked structure of the positive electrode and the negative electrode structure, from a point where the top or bottom outermost stack portion (10A′) ends, and has both straight and curved shapes in the embodiment shown in FIG. 2.

As shown in the embodiment depicted in FIG. 1, the negative electrode structure (10) has wrapping portions (10C) at both ends thereof relative to the longitudinal direction. That is, two wrapping portions (10C) are located at each of the longitudinal ends of the negative electrode structure (10). Furthermore, each of the wrapping portions (10C) contacts an outermost stack portion (10A′), and between the outermost stack portions (10A′), the folding portion (10B) and the stack portion (10A) are located alternately. According to certain aspects, the lengths of the stack portions (10A, 10A′) may be substantially equal to the length of the positive electrode, and thus the length of each stack portion (10A, 10A′) may be substantially the same.

According to certain embodiments, the two wrapping portions (10C) located at both ends of the negative electrode structure (10) may have different lengths. In order to distinguish the two wrapping portions (10C), the wrapping portion (10C) located at the point where the stacking begins is named the first wrapping portion, and the wrapping portion (10C) located at the point where the stacking ends is named the second wrapping portion. For example, in FIG. 1, if the stack is started from the left portion, the wrapping portion (10C) located at the left end is the first wrapping portion, and the wrapping portion (10C) located at the right end is the second wrapping portion. According to certain embodiments, the first wrapping portion and the second wrapping portion are not required to necessarily have the same length, as long as they can wrap around one side of the interior of the electrode assembly. However, according to certain aspects, by adjusting the process conditions in a repeated process to equalize the lengths of the first wrapping portion and the second wrapping portion so that the electrode assembly has a symmetrical structure, the structural stability of the electrode assembly can be increased. According to one embodiment of the present disclosure, the first wrapping portion and the second wrapping portion have the same length as each other.

The negative electrode structure (10) together with a plurality of positive electrodes forms an electrode assembly. For a better understanding of the structure of the electrode assembly, FIG. 2 provides an exemplary structure of an electrode assembly including a negative electrode structure and a positive electrode. Since the negative electrode structure (10) includes a negative electrode (11) and separating films (12), the electrode assembly (1) includes a positive electrode (10), a negative electrode (11) and separating films (12).

According to one embodiment of the present disclosure, the electrode assembly (1) has a plurality of stack portions (10A, 10A′) sequentially positioned side by side in the thickness direction by the folding portion (10B), and at least one positive electrode is positioned between the stack portions (10A, 10A′) that are adjacent to each other in the thickness direction. According to one embodiment of the present disclosure, the electrode assembly (1) has a configuration in which an exterior, in the thickness direction and the longitudinal direction, is defined by the first and second wrapping portions (10C), or the first and second wrapping portions and at least one outermost stack portion (10A′). In other words, the interior of the electrode assembly (1) has a configuration in which the stack portions (10A, 10A′) of the negative electrode structure and the positive electrode (20) are stacked sequentially in an alternating manner. In this case, only one positive electrode (20) is located between adjacent stack portions (10A, 10A′) of the negative electrode structure. Furthermore, according to certain embodiments, the exterior of the electrode assembly (1) is defined by at least one stack portion (10A′) of the negative electrode structure and two wrapping portions (10C) of the negative electrode structure. The interior and exterior of the electrode assembly (1) are distinguished for the purpose of understanding the structure of the electrode assembly (1) according to the present disclosure, and in FIG. 2, the layer exposed to the outside of the electrode assembly (1) in the thickness direction and the longitudinal direction indicates the exterior of the electrode assembly (1), and the interior of the electrode assembly (1) is internal to this exterior. In the negative electrode structure (10), since the stack portions (10A, 10A′) correspond to parts of the negative electrode structure (10) that are located at positions where the positive electrodes are stacked, and the wrapping portion (10C) starts from the point where the top or bottom outermost stack portion (10A′) ends, when an end of the first wrapping portion (10C) is located on top of the outermost stack portion (10A′), as shown in FIG. 2, a portion of the outermost stack portion (10A′) may be located on the exterior of the electrode assembly (1), and a remaining portion of the outermost stack portion (10A′) may be located on the interior of the electrode assembly (1). Moreover, when an end of the second wrapping portion (10C) is located on the bottom outermost stack portion (10A′), a portion of the bottom outermost stack portion (10A′) may be located on the exterior of the electrode assembly (1), and a remaining portion of the bottom outermost stack portion (10A′) may be located on the interior of the electrode assembly (1). Thus, as used herein, an outermost stack portion that is located inside or outside may include all or just a part of one stack portion. Unlike FIG. 2, if one of the first and second wrapping portions (10C) covers the entire outermost stack portion (10A′), the exterior of the electrode assembly (1) may be formed by only the first or second wrapping portions (10C). According to certain aspects, the plurality of folding portions (10B) are wrapped by the wrapping portion (10C) so that they are not exposed to the outside in the thickness direction and the longitudinal direction.

Since the electrode assembly (1) according to one embodiment of the present disclosure has the stack portions (10A, 10A′) of the negative electrode structure (10) and the positive electrode (20) stacked alternately and sequentially therein, the negative electrode structure (10) including the folding portion (10B) has a zigzag shape. In other words, according to certain aspects, the folding portions (10B), which are located sequentially from the stack portion (10A′) in contact with the first or second wrapping portion of the negative electrode structure (10), are located alternately on the left or right side of the electrode assembly (1). If the stack portions (10A, 10A′) of the negative electrode structure (10) and the positive electrode (20) are not stacked alternately, and two or more of the stack portions or the positive electrodes are stacked successively, a potential difference may not occur between the successively stacked layers, and the efficiency of the battery may be reduced.

According to one embodiment of the present disclosure, in the electrode assembly (1), the plurality of stack portions (10A, 10A′) and the plurality of positive electrodes (20) are pressed closer to each other in the thickness direction by the first and second wrapping portions (10C). The first and second wrapping portions (10C) can wrap the interior of the electrode assembly (1) with a higher tension compared to the stack portions (10A, 10A′) or the folding portion (10B), which can cause the internal components of the electrode assembly (1) to be pressed closer to each other in the thickness direction. When the internal components of the electrode assembly (1) are pressed closer to each other in the thickness direction by this method, according to certain aspects, the internal components of the electrode assembly (1) become inevitably closer to each other in the longitudinal direction. However, even if the internal components of the electrode assembly (1) are pressed closer to each other in the thickness direction and the longitudinal direction, there may be a certain amount of voids around the folding portion (10B) due to the structure of the electrode assembly (1).

According to one embodiment of the present disclosure, the first wrapping portion and the second wrapping portion do not contact each other, but are fixed on different outermost stack portions (10A′) of the negative electrode structure. In other words, according to certain aspects, the first wrapping portion and the second wrapping portion do not overlap in forming the exterior of the final electrode assembly. If the first wrapping portion and the second wrapping portion overlap, according to certain aspects, an unnecessary amount of the negative electrode structure is used as the overlapping portion, which is undesirable in terms of material optimization. As described above, the end of the first wrapping portion and the end of the second wrapping portion may be located on outer-most stack portions, and the outer-most stack portion on which the end of the first wrapping portion is located and the outer-most stack portion on which the end of the second wrapping portion is located may be different in order to form an efficient structure of the electrode assembly.

According to one embodiment of the present disclosure, in the electrode assembly (1), one positive electrode is located between the stack portions (10A, 10A′) which are adjacent to each other in the thickness direction, and the total number of positive electrodes (20) located between the stack portions (10A, 10A′) is 2n (where n is a natural number). Since there is only one positive electrode (20) between the adjacent stack portions (10A, 10A′) in the electrode assembly (1), the number of total positive electrodes herein refers to the total number of positive electrodes in this same situation, and does not mean that 2n positive electrodes are stacked between the stack portions. For example, in FIG. 2, the total number of positive electrodes located between the stack portions is 4. In the electrode assembly according to one embodiment of the present disclosure, all of the positive electrodes (20) are located between the stack portions. The upper limit of the number of total positive electrodes (20) is not particularly limited and may be adjusted within the conventional range in the art. According to one embodiment, when the number of total positive electrodes (20) located between the stack portions (10A, 10A′) is 2n, the end of the first wrapping portion is opposite the end of the second wrapping portion. For example, in FIG. 2, the end of the first wrapping portion is on the left side, and the end of the second wrapping portion is on the right side. In this case, even if the left and right sides inside the electrode assembly are wrapped with the first wrapping portion and the second wrapping portion, respectively, the first wrapping portion and the second wrapping portion may not overlap each other, and an electrode assembly with an efficient structure can be manufactured.

According to one embodiment of the present disclosure, the number of stack portions (10A, 10A′) in the electrode assembly (1) may be one more than the number of positive electrodes (20). As described above, if 2n (wherein n is a natural number) total positive electrodes (20) are to be located between the stack portions, the number of stack portions (10A, 10A′) is 2n+1 (wherein n is a natural number).

According to one embodiment of the present disclosure, the positive electrode (20) comprises a positive electrode active material layer (not shown in the drawing), and a current collector supporting the positive electrode active material (not shown in the drawing). The positive electrode (20) has a structure in which a positive electrode active material layer is formed on at least one side, and preferably on both sides, of the current collector. The positive electrode active material layer comprises a positive electrode active material and may further comprise a conductive material, a binder and an additive. The current collector, positive electrode active material, conductive material, binder or additive is not particularly limited as long as it is commonly used in the art.

The positive electrode current collector supports the positive electrode active material layer and is not particularly limited, typically having a high conductivity without causing any chemical changes in the battery. According to one embodiment of the present disclosure, the positive electrode current collector may be made of copper, stainless steel, aluminum, nickel, titanium, palladium, calcined carbon, copper or stainless steel whose surface is treated with carbon, nickel or silver, or aluminum-cadmium alloy.

According to certain embodiments, the positive electrode current collector can have microscopic irregularities on its surface to strengthen the binding with the positive electrode active material, and various forms can be used, such as films, sheets, foils, meshes, nets, porous materials, foams, non-woven materials, etc.

According to certain embodiments, as the positive electrode active material, a lithium-containing transition metal oxide may be used. According to one embodiment of the present disclosure, any one or a mixture of the two or more selected from the group consisting of LiCoO₂, LiNiO₂, LiMnO₂, LiMn₂O₄, Li(NiₐCo_{b}Mn_{c})O₂ (wherein 0<a<1, 0<b<1, 0<c<1, and a+b+c=1), LiNi_{1-y}CO_{y}O₂ (wherein 0<y<1), LiCo_{1-y}Mn_{y}O₂ (wherein 0<y<1), LiNi_{1-y}Mn_{y}O₂ (wherein 0<y<1), Li(NiₐCo_{b}Mn_{c})O₄ (wherein 0<a<2, 0<b<2, 0<c<2, and a+b+c=2), LiMn_{2-z}Ni_{z}O₄ (wherein 0<z<2), LiMn_{2-z}CO_{z}O₄ (wherein 0<z<2), LiCoPO₄ and LiFePO₄ can be used. In addition to these oxides, sulfides, selenides or halides can be used.

The positive electrode active material may comprise a sulfur compound. According to one embodiment of the present disclosure, the sulfur compound may be at least one selected from the group consisting of elemental sulfur (S₈), organosulfur compound Li₂Sₙ (wherein n≥21), and carbon-sulfur polymer ((C₂Sₓ)n, wherein x is 2.5 to 50, and n≥1). Preferably, inorganic sulfur (S₈) may be used.

When the positive electrode active material comprises a sulfur compound, the electrode assembly (1) according to one embodiment of the present disclosure can be applied to a lithium-sulfur battery. Since the sulfur itself contained in the positive electrode active material is not electrically conductive, it may be used in combination with a conductive material such as a carbon material. Accordingly, the sulfur is included in the form of a sulfur-carbon composite, and preferably, the positive electrode active material may be a sulfur-carbon composite.

In view of the foregoing, according to certain aspects, the positive electrode (20) may be one that is relatively less easily folded and more easily cut compared to the negative electrode. Thus, the positive electrode (20) may be cut to a suitable size so that a plurality of positive electrodes can be provided to the interior of the electrode assembly (1).

According to one embodiment of the present disclosure, the negative electrode (11) does not include a current collector supporting the lithium metal layer. Since the negative electrode (11) does not include a current collector, the loading amount of the negative electrode active material within the electrode assembly can be improved, which can contribute to improved performance of the battery. When the negative electrode (11) is mainly composed of lithium metal, it may not be easy to process, such as by cutting, because the lithium metal is highly ductile and viscous, but in the electrode assembly (1) according to one embodiment of the present disclosure, the processability can be improved by minimizing cutting while the negative electrode is applied in the form of the negative electrode structure (10). The lithium metal layer according to one embodiment of the present disclosure may be a free-standing lithium metal layer that can retain the shape to a certain extent by itself.

According to certain embodiments, the separating film (12) covering both sides of the negative electrode (11) in the negative electrode structure (10) is not particularly limited in terms of type, provided that it does not include a binder on its surface. The separating film (12) may be a nonwoven or polyolefin-based porous material made of, for example, a glass fiber having a high melting point or a polyethylene terephthalate fiber, but is not limited thereto.

The material of the porous material is not particularly limited according to aspects of the present disclosure, but any porous material conventionally used in electrochemical devices can be used. According to one embodiment of the present disclosure, the porous material may include at least one selected from the group consisting of polyolefin such as polyethylene or polypropylene, polyester such as polyethyleneterephthalate or polybutyleneterephthalate, polyamide, polyacetal, polycarbonate, polyimide, polyetheretherketone, polyethersulfone, polyphenyleneoxide, polyphenylenesulfide, polyethylenenaphthalate, polytetrafluoroethylene, polyvinylidene fluoride, polyvinyl chloride, polyacrylonitrile, cellulose, nylon, poly(p-phenylene benzobisoxazole), and polyarylate.

According to one embodiment of the present disclosure, the lengths (as measured in the longitudinal direction) of the negative electrode (11) and the first and second separating films (12) in the negative electrode structure (10) are the same. With reference to the end of the negative electrode structure (10) where the wrapping portion (10C) is located, the separating film located on the exterior of the electrode assembly (1) may be named the first separating film, and the separating film located on the interior of the electrode assembly (1) may be named the second separating film. According to certain embodiments, the negative electrode (11) and the separating films (12) are provided to the electrode assembly (1) in the form of a negative electrode structure (10) having the negative electrode (11) interposed between the first and second separating films (12), wherein the negative electrode and the separating film are cut at one time, so that the lengths of the negative electrode (11) and the first and second separating films (12) in the negative electrode structure (10) are substantially the same, as shown in FIG. 1. However, depending on the method of cutting the negative electrode structure (10), there may be slight differences in the lengths of the negative electrode (11) and the first and second separating films (12), and in some cases, the ends of the first and second separating films (12) may be bent toward the center of the negative electrode structure (10). According to one embodiment of the present disclosure, the first and second separating films are folded at the end of the negative electrode structure (10). Although the negative electrode structure (10) may have substantially the same length of the negative electrode (11) and the first and second separating films (12) during the supplying process, according to certain embodiments, when used in the electrode assembly (1), the length of the lithium metal may be extended due to the ductility of the lithium metal during the folding process. According to one embodiment of the present disclosure, at the end of the negative electrode structure (10) on the side of the wrapping portion (10C), the lithium metal protrudes longer than the first and second separating film. Also, depending on the number of folds, the separating film located more on the outer side than on the inner side of the folding portion (10B) may be shorter in the electrode assembly 1. According to one embodiment of the present disclosure, the first separating film protrudes longer than the second separating film at the end of the negative electrode structure (10) on the side of the first or second wrapping portion (10C). According to one embodiment of the present disclosure, the second separating film protrudes longer than the first separating film at the end of the negative electrode structure (10) on the side of the first or second wrapping portion (10C).

According to one embodiment of the present disclosure, the end of the first wrapping portion is located on an outermost stack portion (10A′) where the first wrapping portion turns to wrap around one side of the adjacent electrode assembly, the outermost stack portion connecting to the second wrapping portion, and the end of the second wrapping portion is located on an opposing outermost stack portion where the second wrapping portion turns to wrap around one side of the adjacent electrode assembly, the opposing outermost stack portion connecting to the first wrapping portion. The ends of the first and second wrapping portions may be positioned in various ways on the respective outermost stack portions (10A′). According to one embodiment of the present disclosure, the first and second wrapping portions, located on the respective outermost stack portions, do not overlap each other in the thickness direction. The longer the first and second wrapping portions are spaced apart in the thickness direction, the less the amount of negative electrode structure is required, which can be efficient. According to one embodiment of the present disclosure, the first wrapping portion and the second wrapping portion, each located on the respective outermost stack portions, overlap each other in the thickness direction. According to certain aspects, the longer the first wrapping portion and the second wrapping portion are overlapped in the thickness direction, the more stable the electrode structure can be. According to one embodiment of the present disclosure, the end of the first wrapping portion and the end of the second wrapping portion are located on the same line in the thickness direction. The position relationship in the thickness direction described above shows whether the first or second wrapping portion overlaps, does not overlap, or has its ends touching each other when the first or second wrapping portion is moved in the thickness direction.

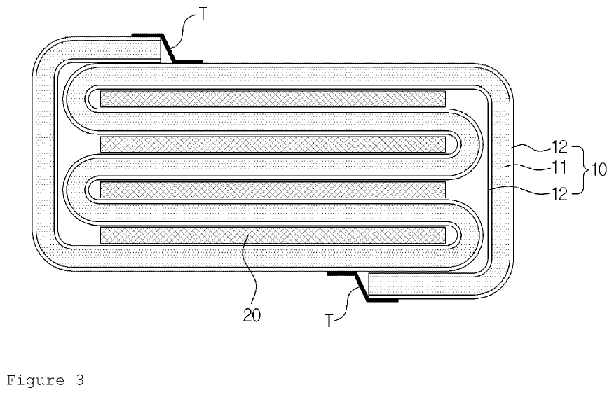

According to one embodiment of the present disclosure, the ends of the first and second wrapping portions (10C) located on the outermost stack portion may be attached to the respective outermost stack portions (10A′). As long as the end of the first or second wrapping portion (10C) can be effectively attached to the respective outermost stack portions (10A′), the means and methods for the attachment are not particularly limited. According to one embodiment of the present disclosure, the electrode assembly (1) further comprises a fixing member for securing the end of the first or second wrapping portion (10C) to the outermost stack portion (10A′). To provide a better understanding of where the end of the wrapping portion (10C) is attached to the negative electrode structure (10), FIG. 3 provides an exemplary configuration of an electrode assembly in which the end of the wrapping portion is attached by a fixing member to the negative electrode structure. Although the negative electrode (11) and the separating film (12) in the negative electrode structure (10) are not in contact, according to the electrode structure in FIG. 3, both ends of the negative electrode structure (10) can be fixed to form a stable structure. As shown in FIG. 3, it may be desirable to attach the tape (T) as a fixing member to wrap around the outer surface of the electrode structure (1). According to one embodiment of the present disclosure, the tape (T) has insulating properties and covers the entire end of the wrapping portion (10C) in the width direction, to accommodate a situation in which the lithium metal is extended and protruded due to the ductility of the lithium metal in the process of folding the negative electrode structure (10) when manufacturing the electrode assembly (1). By this taping method, according to certain embodiments, the electrode assembly (1) is covered with a separating film or a tape from top to bottom (thickness direction) and left to right (longitudinal direction).

According to certain embodiments, in manufacturing the electrode assembly (1), when the stack portions (10A, 10A′) of the negative electrode structure (10) and the positive electrode (20) are stacked alternately, the negative electrode structure (10) is folded according to the same criteria for each fold, so that the folding portions (10B) also have substantially the same length as each other. According to certain embodiments, the negative electrode structure (10) utilizes a particular form of mandrel to apply the same criteria when folding. According to certain embodiments, if the folding portion (10B) has an excessively shorter length, an unnecessary load may be imposed on the lithium metal located in the center of the negative electrode structure (10), resulting in a defect such as a break in the lithium metal. Therefore, according to certain aspects, securing a sufficient length of the folding portion (10B) above a certain level enables the lithium metal to be flexibly disposed in the void between the portion in which the electrodes are stacked and the wrapping portion.

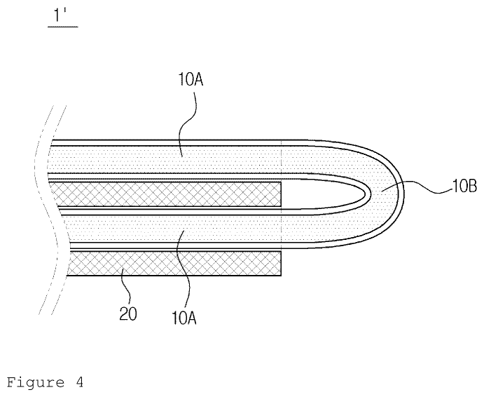

For a better understanding of the length of the folding portion (10B) in the negative electrode structure (10), FIG. 4 provides a close-up drawing of a portion of a folding portion (10B) in the electrode assembly (1), according to one embodiment. According to one embodiment of the present disclosure, the length of the folding portion (10B) in the negative electrode structure (10) is from 2 to 10 times the sum of the thicknesses of the single positive electrode (20) and a single stack portion of the negative electrode structure (10). The length of the folding portion (10B) means the length of the curve of the folding portion. In a curve, since the lengths of the inner and outer sides may be different from each other, the length of the center portion is measured. For example, the length can be measured by cutting the portion indicated by the dotted line in FIG. 4 and then unfolding it. Specifically, the length of the folding portion (10B) may be 2 times or more, 2.5 times or more, 3 times or more, 3.5 times or more, 4 times or more, 10 times or less, 9.5 times or less, 9 times or less, 8.5 times or less, 8 times or less, 2 to 10 times, 3 to 9 times, or 4 to 8 times the sum of the thicknesses of the positive electrode (20) and the negative electrode structure (10). According to certain embodiments, when the length of the folding portion (10B) is adjusted within the above ranges, the defect of the folding portion in the electrode assembly can be reduced, and the electrode assembly can be stably wrapped.

According to certain embodiments, the length of the folding portion (10B) described above indicates that it is formed longer or oblate, as shown in FIG. 4, rather than being folded into a semicircle as shown in FIG. 2. Specifically, when the folding portion (10B) has the form of a complete semicircle with an eccentricity of 0, the length of the folding portion becomes the sum of the thicknesses of a single positive electrode (20) and a single stack portion of the negative electrode structure (10), which are the diameter, multiplied by n and divided by 2. This is approximately 1.57 times the sum of the thicknesses of the positive electrode (20) and the negative electrode structure (10). Based on this, it can be seen that the length of the folding portion (10B) according to one embodiment of the present disclosure is significantly long.

According to one embodiment, in manufacturing the electrode assembly (1), after stacking the stack portions (10A, 10A′) of the negative electrode structure (10) and the positive electrode (20) in an alternating manner, and wrapping the electrode laminate (1) by the wrapping portion (10C), the folding portions (10B) are subjected to a certain level of pressure pressing them in the inward direction of the electrode assembly (1). Accordingly, in certain embodiments, the folding portions (10B) can be appropriately disposed in the void between the parts of the electrode assembly where the electrodes are stacked and the wrapping portion. According to certain aspects, since the folding portions (10B) that may be suitably disposed in the void includes the lithium metal layer (11) therein, they can contribute to further battery performance improvement by electrochemical reaction with the positive electrodes (20) on the sides thereof. Two or more lithium metal layers may also be located on the sides of the positive electrodes that are not wrapped by the folding portion (10B), as the adjacent folding portion(s) (10B) appropriately fills the void. According to certain embodiments, wrapping the electrode assembly (1) with the wrapping portion (10C) so that the wrapping portion (10C) has a tension above a certain level, can help to maintain the configuration of the electrode laminate located in the electrode assembly (1) without distortion.

According to one embodiment of the present disclosure, the folding portions (10B) have an asymmetrical shape with respect to a plane along the longitudinal direction. According to certain aspects, this asymmetrical shape may be formed when the folding portions (10B) are pressed inwardly in the longitudinal direction by the wrapping portion (10C) so that the folding portions (10B) are properly positioned in the void. According to one embodiment of the present disclosure, a center point of the length of the folding portions (10B) is not aligned with a center point of the thickness of the positive electrode that each folding portion (10B) respectively wraps around. The center point of the length of the folding portions (10B) may be oriented in the direction of wrapping relative to the center point of the thickness of the positive electrode that each folding portion (10B) respectively wraps around. For example, referring to FIG. 2, folding portions located on the right side of the electrode assembly may have center points of the lengths of the folding portions that are below the center points of the thickness of the positive electrodes they are folded about because the wrapping proceeds from top to bottom. In contrast, the folding portions on the left side of the electrode assembly may have center points of the lengths of the folding portions that are above the center points of the thickness of the positive electrodes they are folded about, because the wrapping proceeds from bottom to top.

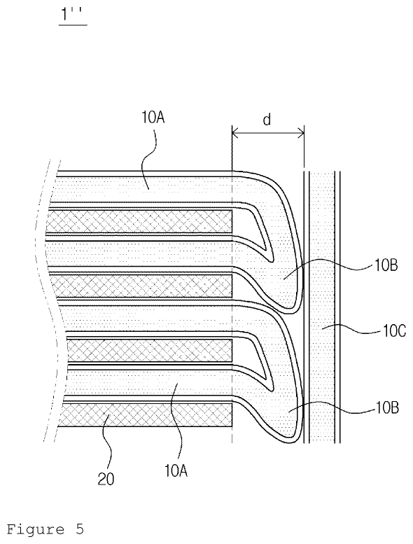

To provide a better understanding of the vertical distance between the end of the positive electrode (20) and the lateral wrapping portion (10C), which is the basis for comparing the length of the folding portion (10B) below, FIG. 5 provides a close-up drawing of an embodiment of the portion of the electrode assembly (1) where the end of the positive electrode (20) and the lateral wrapping portion (10C) are located. As shown in FIG. 5, the folding portion (10B) may be deformed by pressure applied from the laterally located wrapping portion (10C) during the process of wrapping the electrode assembly. However, FIG. 5 is only an exemplary structure and the folding portions (10B) do not necessarily have the deformation corresponding to this shape. According to certain embodiments, due to the pressure, the distance (d) between the end of the positive electrode (20) and the lateral wrapping portion (10C) may be shortened, and, as the distance (d) is shortened, the folding portions (10B) may be naturally arranged within the shortened space. According to one embodiment of the present disclosure, the lengths of the folding portions (10B) in the electrode assembly (1) are from 2 to 10 times the vertical distance (d) between the end of the positive electrode (20) and the lateral wrapping portion (10C). The part of the lateral wrapping portion (10C) referred to here is the straight-shaped part of the wrapping portion (10C) located on the left or right side of the electrode assembly in FIG. 2 or FIG. 3. If the corresponding portion in the actual electrode assembly is not straight, the vertical distance (d) is measured as the vertical distance from the lateral wrapping portion to the end of the positive electrode at the center portion of the electrode assembly in the thickness direction. Alternatively, the vertical distance (d) can be measured as the average value of the vertical distance from the end of each positive electrode (20) to the portion where the wrapping portion (10C) abuts the respective folding portion (10B) on one side. Specifically, the length of each of the folding portion (10B) may be 2 times or more, 2.5 times or more, 3 times or more, 3.5 times or more, 4 times or more, 10 times or less, 9.5 times or less, 9 times or less, 8.5 times or less, 8 times or less, 2 times to 10 times, 3 times to 9 times, or 4 times to 8 times the vertical distance (d) between the end of the positive electrode (20) and the lateral wrapping portion (10C). This means that, according to certain embodiments, the lengths of the folding portions (10B) may be significantly longer as described above, but the vertical distance (d) is also shorter, so that the folding portions are compactly packed in the lateral space of the electrode assembly. When the length of the folding portions (10B) are adjusted within the above range, according to certain embodiments, the folding portions can be compactly packed into the void(s) in the electrode assembly to an appropriate degree without exerting excessive pressure on the folding portion by wrapping of the electrode assembly, thereby contributing to improved performance of the battery.

According to one embodiment of the present disclosure, the basic structure of the electrode assembly (1) is formed by folding one negative electrode structure (10), and the negative electrode structure (10) should not be excessively thick so that it can be flexibly folded, and a certain level of lithium metal, a negative electrode active material, should be secured in the negative electrode structure (10) in consideration of the performance of the battery. According to one embodiment of the present disclosure, the thickness of the lithium metal in the negative electrode structure (10) accounts for 50% to 90% based on the total thickness of the negative electrode structure (10). Specifically, the thickness of the lithium metal may range from 50% to 90%, specifically from 55% to 85%, and more specifically from 60% to 80%. When the lithium metal satisfies the above-mentioned thickness range, it can help improve the processability and functionality of the electrode assembly. According to one embodiment of the present disclosure, since the negative electrode structure (10) does not include a separate current collector, the thickness of the remaining portion excluding the lithium metal may refer to the thickness of two separating films.

According to one embodiment of the present disclosure, the thickness of the lithium metal may be from 10 μm to 90 μm. Specifically, the thickness of the lithium metal may be 10 μm or more, 20 μm or more, or 30 μm or more, and may be 70 μm or less, 80 μm or less, or 90 μm or less. The thickness of the lithium metal is not necessarily limited thereto, and may be appropriately adjusted according to the actual size of the battery.

In the electrode assembly (1) according to one embodiment of the present disclosure, unlike the negative electrode structure (10), the positive electrode is cut in consideration of characteristics such as the material used for the positive electrode, and provided between the stack portions (10A, 10A′) of the negative electrode structure (10). Although the positive electrode is distinct and independent from the negative electrode, in terms of, for example, including a current collector in addition to the positive electrode active material, the thickness may be adjusted in relation to the negative electrode or the negative electrode structure in consideration of the performance of the electrode. According to one embodiment of the present disclosure, the thickness of the positive electrode (20) is greater than the thickness of the negative electrode structure (10). According to one embodiment of the present disclosure, the thickness of the positive electrode (20) has a thickness of more than 100% and less than 400% with respect to the thickness of the negative electrode structure (10). Specifically, the thickness of the positive electrode (20) may range from 100% greater than or less than 400%, specifically from 150% to 350%, and more specifically from 200% to 300%. According to certain embodiments, when the positive electrode satisfies the above-described thickness range, it can be suitably matched with the negative electrode structure.

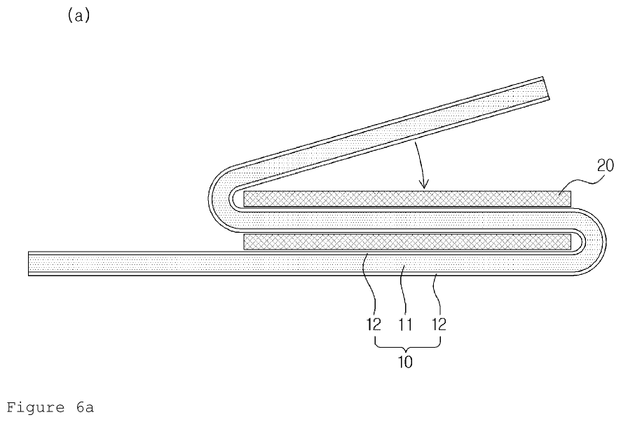

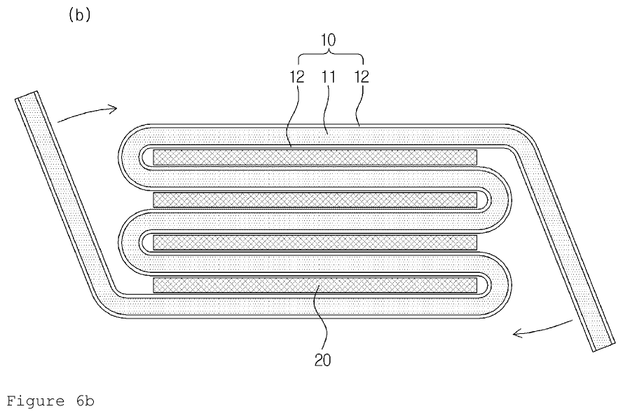

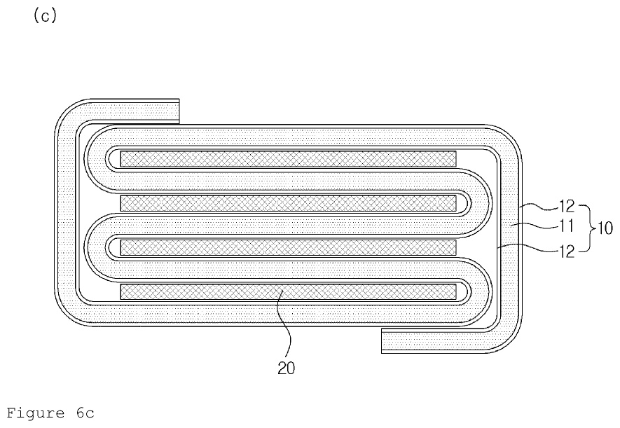

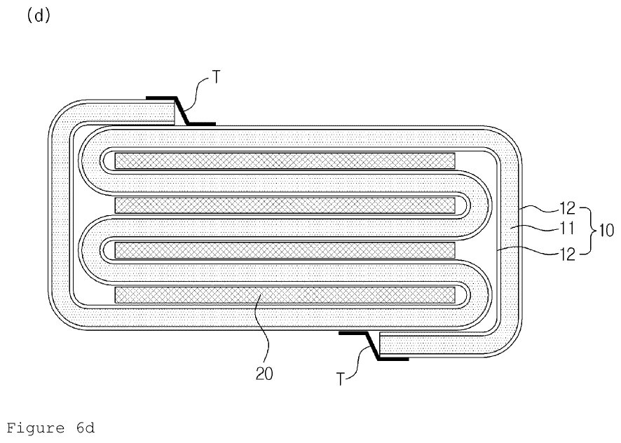

Hereinafter, a detailed description of an embodiment of a process for manufacturing the electrode assembly is provided. To facilitate an understanding of the manufacturing process of the electrode assembly according to this embodiment, FIG. 6 schematically illustrates a process and a state in the manufacturing process of the electrode assembly.

A manufacturing process for the electrode assembly according to one embodiment of the present disclosure includes the steps of (1) folding a negative electrode structure to form an electrode laminate in which a positive electrode and a negative electrode structure are alternatively stacked; (2) surrounding the electrode laminate with excess negative electrode structure after manufacturing the electrode laminate; and (3) positioning and securing the end of the negative electrode structure to the top of the electrode laminate.

The step (1) is exemplarily manufactured through the process as shown in FIG. 6a. As shown in FIG. 6a, the negative electrode structure and the positive electrode can be stacked sequentially, with the negative electrode structure at the bottom and the positive electrode thereon. Also, although not shown in FIG. 6a, a device such as a mandrel may be utilized to fold the negative electrode structure so that the folds at each location are made according to the same criteria. Stacking starts not from the end of the negative electrode structure, but the stack portion in contact with the first wrapping portion, with enough of the first wrapping portion remaining to cover one side of the electrode laminate at a later point. The step (2) is exemplarily manufactured through the process as shown in FIG. 6b. The extra amount of negative electrode structure is present at both ends as first and second wrapping portions, and the first and second wrapping portions each wrap the side of an adjacent electrode laminate. During the process of wrapping with the extra negative electrode structure, the negative electrode structure can be wrapped such that it is under a certain level of tension, which may help to compactly pack the folding portions within the void and help the structure of the electrode laminate to maintain its shape without distortion. After the step (3), the finished electrode assembly is in a state as shown in FIG. 6c or FIG. 6d. According to certain embodiments, he wrapping can have the effect of preventing the positive electrode from sliding down between the stack portions, and considering this function, it may be desirable to position the end of the negative electrode structure at the top of the electrode laminate. By securing the negative electrode structure, the tension applied to the negative electrode structure during the wrapping process may be maintained, and wrapping with tape (T) as shown in FIG. 6d may be provided in an exemplary method.

Specific characteristics of the positive electrode and negative electrode structures not specifically described in the manufacturing process are in accordance with the foregoing detailed description. An electrode assembly according to one embodiment of the present disclosure can also have multiple layers of welded tabs and leads, such as in conventional large capacity cells, to maintain performance such as cell resistance and output.

An electrode assembly according to one embodiment of the present disclosure is used in an electrochemical device. The electrochemical device may comprise any device that performs an electrochemical reaction. For example, the electrochemical device may be any kind of primary battery, secondary battery, fuel battery, solar battery or capacitor. If the electrochemical device is a secondary battery, the electrochemical device may be a lithium secondary battery, which may include a lithium metal secondary battery, a lithium ion secondary battery, a lithium polymer secondary battery or a lithium ion polymer secondary battery.

As shown above, although the embodiments have been described by limited examples and drawings, one of ordinary skill in the art can make various modifications and variations in view of the above descriptions. For example, even if the provided techniques may be performed in a different order from the above-described methods, and/or the provided components such as the systems, structures, devices, circuits, etc. may be combined in a different form from the above-described methods, or substituted or replaced by other components or equivalents, the desired results can be achieved.

Hereinafter, Examples are presented to facilitate an understanding of the present disclosure. The following Examples are provided to illustrate the present disclosure, but the present disclosure is not limited thereto.

### EXAMPLE

### Example 1: Manufacture of an Electrode Assembly Wrapped With a Negative Electrode Structure

The negative electrode structure was prepared by interposing 60 μm of lithium metal between two polyethylene (PE) separating films (11 μm). In addition, a positive electrode compound composed of 85 wt % of positive electrode active material prepared by mixing sulfur and carbon nanotubes (CNTs) in a weight ratio of 7:3, 5 wt % of carbon nanofiber as a conductive material, and 10 wt % of binder was added to deionized water to prepare a positive electrode slurry, and then an aluminum collector was coated with the positive electrode slurry to produce a 200 μm positive electrode.

The manufactured negative electrode structures were folded to make an electrode laminate in the manner shown in FIG. 6a, and then the electrode laminate was wrapped with excess negative electrode structures in the manner shown in FIG. 6b to make an electrode assembly as shown in FIG. 6c. The exposed end of the negative electrode structure in the electrode assembly was fixed with insulating tape as shown in FIG. 6d. In the electrode assembly, the length of the folding portion was measured as 1,453 μm, and the vertical distance between the end of the positive electrode and the lateral wrapping portion was measured as 268 μm.

### Comparative Example 1: Manufacture of an Electrode Assembly in Which the Negative Electrode Structure is Cut and Laminated

The negative electrode structure was cut to fit the positive electrode of each layer, and then the positive electrode and the negative electrode structure were laminated to form an electrode laminate, and the electrode assembly was completed without any separate wrapping with the negative electrode structure. In the electrode assembly, the material and thickness of the positive electrode and the negative electrode structure were the same as in Example 1.

### Experimental Example

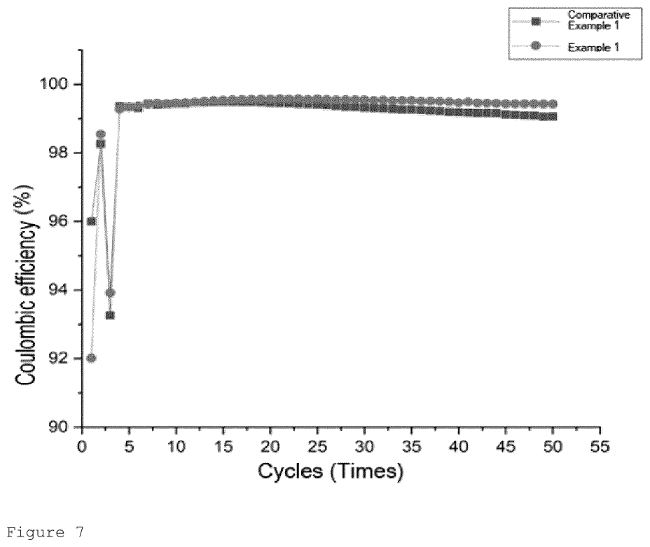

Each electrode assembly prepared according to Example 1 and Comparative Example 1 was placed in the same pouch, and the ether-based electrolyte is charged with 0.4 M of LiFSI salt and 4 wt % of LiNO₃ to prepare a lithium secondary battery. The Coulombic efficiency of the prepared lithium secondary battery was measured by charging and discharging it at 0.3 C, and the results are shown in FIG. 7.

Not only does the electrode assembly according to the present disclosure have advantages over conventional electrode assemblies in terms of process, but according to FIG. 7, it can be seen that the long-term performance of the battery, such as Coulombic efficiency, can also be improved.

All simple variations or modifications of the present invention fall within the scope of the present disclosure, and the specific scope for which protection is sought is to be clear by the appended claims.

### REFERENCE NUMERALS

1, 1′, 1″: Electrode assembly
10: Negative electrode structure
10A, 10A′: Stack portion (10A′: Outermost stack portion)
10B: Folding portion
10C: Wrapping portion (First and second wrapping portions)
11: Negative electrode (Lithium metal layer)
12: Separating film (First and second separating films)
20: Positive electrode
T: Fixing member (Tape)
d: Vertical distance between the end of the positive electrode and the lateral wrapping portion

1. An electrode assembly comprising a negative electrode structure and a plurality of positive electrodes,
wherein the negative electrode structure comprises first and second separating films, and a negative electrode comprising a lithium metal layer interposed between the first and second separating films, wherein the negative electrode structure is divided into a plurality of stack portions, a plurality of folding portions, and first and second wrapping portions according to their positions in the electrode assembly, wherein the plurality of stack portions and the plurality of folding portions are positioned in an alternating manner between the first and second wrapping portions located at respective ends of the negative electrode structure, and wherein each of the first and second wrapping portions abut at least one of the plurality of stack portions,
wherein the plurality of stack portions are sequentially positioned side by side in a thickness direction and connected together by the plurality of folding portions, and each of the plurality of positive electrodes is positioned between stack portions that are adjacent to each other in the thickness direction,
wherein an exterior of the electrode assembly in the thickness direction and a longitudinal direction is defined by first and second wrapping portions, or is defined by the first and second wrapping portions and at least one outermost stack portion.

2. The electrode assembly according to claim 1, wherein the plurality of stack portions and the plurality of positive electrodes are pressed closer to each other in the thickness direction by the first and second wrapping portions.

3. The electrode assembly according to claim 1, wherein the first wrapping portion and the second wrapping portion do not contact each other.

4. The electrode assembly according to claim 1, wherein the first wrapping portion and the second wrapping portion have the same length as each other.

5. The electrode assembly according to claim 1, wherein the first wrapping portion and the second wrapping portion are secured to different outermost stack portions.

6. The electrode assembly according to claim 1, wherein in the electrode assembly, each of the plurality of positive electrodes is positioned between stack portions of the plurality of stack portions that are adjacent to each other in the thickness direction, and
a total number of positive electrodes located between the stack portions of the plurality of stack portions that are adjacent to each other is 2n, wherein n is a natural number.

7. The electrode assembly according to claim 1, wherein each of the plurality of positive electrodes comprises a positive electrode active material layer, and a current collector supporting the positive electrode active material layer, and the negative electrode structure does not comprise a current collector supporting the lithium metal layer.

8. The electrode assembly according to claim 1, wherein the lithium metal layer and the first and second separating films in the negative electrode structure have the same length.

9. The electrode assembly according to claim 1, wherein, in the negative electrode structure, an end of the first wrapping portion is located on a stack portion that connects to the second wrapping portion, wherein the first wrapping portion turns to wrap around a side adjacent to one side of the electrode assembly, and an end of the second wrapping portion is located on a stack portion that connects to the first wrapping portion, wherein the second wrapping portion turns to wrap around a side adjacent to the other side of the adjacent electrode assembly.

10. The electrode assembly according to claim 1, wherein the electrode assembly further comprises a fixing member for securing the ends of the first and second wrapping portions to the at least one outermost stack portion, respectively.

11. The electrode assembly according to claim 1, wherein lengths of the plurality of folding portions in the negative electrode structure are from 2 to 10 times the sum of the thicknesses of the positive electrode and the negative electrode structure.)

12. The electrode assembly according to claim 1, wherein, in the negative electrode structure, the length of the folding portion are from 2 to 10 times the vertical distance between the end of the positive electrode and the lateral wrapping portion surrounding it.

13. The electrode assembly according to claim 1, wherein the plurality of folding portions haves an asymmetrical shape with respect to a plane along the longitudinal direction.

14. The electrode assembly according to claim 1, wherein a thickness of the lithium metal layer in the negative electrode structure is from 50% to 90% based on an overall thickness of the negative electrode structure.

15. The electrode assembly according to claim 1, wherein a thickness of each of the plurality of positive electrodes is greater than a thickness of the negative electrode structure.

16. The electrode assembly according to claim 10, wherein the fixing member is an insulating tape.

17. The electrode assembly according to claim 1, wherein a center point of the length of each of the plurality of folding portions is not aligned with a center point of the thickness of each of the plurality of positive electrodes respectively surrounded by the plurality of folding portions.

18. The electrode assembly according to claim 9, wherein the first wrapping portion and the second wrapping portion, each located on the stack portion, do not overlap each other in the thickness direction.

19. The electrode assembly according to claim 9, wherein the first wrapping portion and the second wrapping portion, each located on the stack portion, overlap each other in the thickness direction.

20. The electrode assembly according to claim 9, wherein the end of the first wrapping portion and the end of the second wrapping portion are located on a same line in the thickness direction.

21. An electrochemical device comprising the electrode assembly according to claim 1.

22. The electrochemical device according to claim 21, wherein the electrochemical device is a lithium secondary battery.

23. The electrochemical device according to claim 22, wherein the electrochemical device is a lithium-sulfur battery.
